(19) United States
(12) Patent Application Publication
(10) Pub. No.: US 2015/0211975 A1
(43) Pub. Date: Jul. 30, 2015

(54) MEASURING DEVICE, MEASURING METHOD, AND COMPUTER-READABLE STORAGE MEDIUM

(71) Applicant: YAMASHIN-FILTER CORP., Kanagawa (JP)

(72) Inventor: Daichi Shigemaru, Kanagawa (JP)

(73) Assignee: YAMASHIN-FILTER CORP., Kanagawa (JP)

(21) Appl. No.: 14/504,628

(22) Filed: Oct. 2, 2014

(30) Foreign Application Priority Data
Jan. 29, 2014 (JP) 2014-014222

(51) Int. Cl. G01N 15/06

(52) U.S. Cl. CPC G01N 15/06

(57) ABSTRACT

There is included a contamination degree acquiring section which acquires a degree of contamination of a liquid due to particles by correcting a sensor value from a measuring sensor, which measures particles in a liquid, based on at least one of a flow rate of the liquid, vibration applied to the measuring sensor, and ambient temperature of the measuring sensor. To provide a technique where it is possible to accurately measure an amount of particles included in a liquid used in a dynamic environment.

### BACKGROUND

1. Technical Field

The present invention relates to a measuring technique.

2. Related Art

Japanese Unexamined Patent Application Publication No. 2013-142626A describes a technique for measuring impurity particles provided with a light emitting diode which emits light with respect to a flow path through which a desired fluid passes, two light receiving elements which are arranged apart from each other in the direction of the flow path of the fluid and which detect light transmitted through the flow path due to the emission of the light, and a detecting section which detects an amount of impurity particles flowing in the flow path from differences in the respective outputs of the light receiving elements.

Measuring an amount of particles included in a liquid is not limited to being carried out in a static environment. When using the technique described in Japanese Unexamined Patent Application Publication No. 2013-142626A to measure the amount of particles included in a liquid used in a dynamic environment such as in, for example, construction machinery, vehicles, or the like, there is a difference between the actual amount of particles and the measured amount.

In light of the foregoing, an object of the present invention is to provide a technique where it is possible to accurately measure an amount of particles included in a liquid used in a dynamic environment.

### SUMMARY

The present application includes a plurality of means for solving the problem described above. Examples of such means include a contamination degree acquiring section which acquires a degree of contamination of a liquid due to particles by correcting a sensor value from a measuring sensor, which measures particles in the liquid, based on at least one of a flow rate of the liquid, vibration of the measuring sensor, and the ambient temperature of the measuring sensor.

According to the technique of the present invention, it is possible to provide a technique where it is possible to accurately measure a degree of contamination due to particles included in a liquid used in a dynamic environment. Problems, configurations, effects, and the like other than those described above will be apparent from the following description of the embodiment.

### BRIEF DESCRIPTION OF THE DRAWINGS

FIG. 1 is a system configuration diagram including a mechanical apparatus of the embodiment.

FIG. 2 is a configuration diagram of a measuring sensor.

FIG. 3 is a hardware configuration diagram for each of a measuring device, a management device, and a management system.

FIG. 4 is an operation flow where the measuring device acquires a degree of contamination C.

FIG. 5 is an example showing a sensor value SO acquired by the measuring sensor, and a flow rate FR of a liquid L in time series.

FIG. 6 is an example showing the sensor value SO output by the measuring sensor, a correction value SC where the sensor value SO is corrected, and the flow rate FR of the liquid L in time series in technique 1.

FIG. 7 is an example showing the sensor value SO output by the measuring sensor, the correction value SC acquired by a contamination degree acquiring section, and the flow rate FR of the liquid L in time series in technique 2.

FIG. 8 is an example showing the sensor value SO in time series in technique 3, with the sensor value SO acquired in various time intervals.

FIGS. 9A to 9C are examples showing, in time series, the sensor value SO in cases where vibration is applied to the measuring sensor and the sensor value SO in cases where vibration is not applied to the measuring sensor.

FIG. 10 is an example of an offset value applied to the sensor value SO according to vibration conditions in the measuring sensor.

FIGS. 11A to 11C are examples showing, in time series, integrated values where the sensor value SO is integrated in cases where vibration is applied to the measuring sensor and integrated values where the sensor value SO is integrated by being offset.

FIG. 12 is an example showing influence of the ambient temperature on the output of an LED.

FIG. 13 is an example showing the sensor value SO output by the measuring sensor and the correction value SC in technique 5.

FIG. 14 is an example where the degree of contamination C is displayed on a display unit.

FIG. 15 is an example where the degree of contamination C is displayed on the display unit.

FIG. 16 is an example where a screen for inputting variables is displayed on the display unit.

### DETAILED DESCRIPTION

Below, detailed description will be given of an embodiment of the present invention with reference to the drawings. Below, in order to simplify the description, the same reference numerals will be given to parts having the same configuration and description thereof will be omitted.

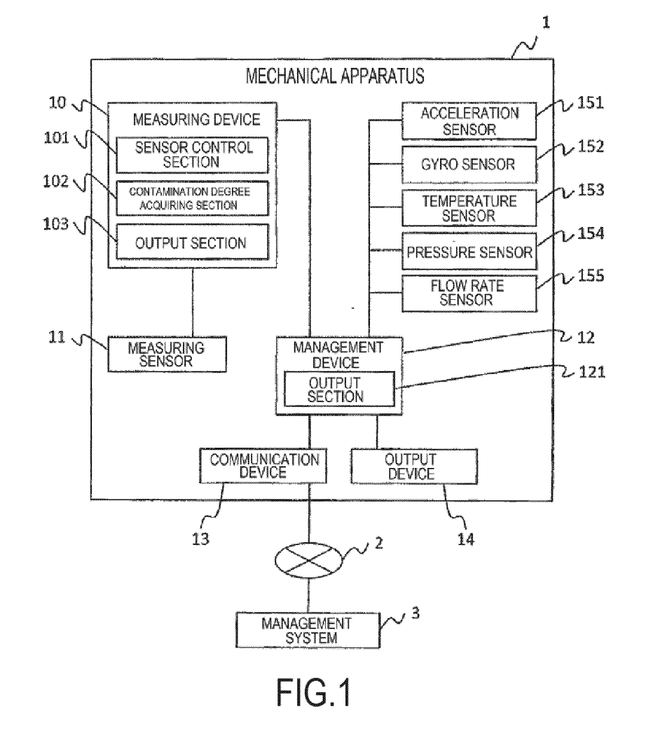

FIG. 1 is a system configuration diagram including a mechanical apparatus (machinery) 1 of the embodiment. The mechanical apparatus 1 referred to here includes a mechanism (not illustrated in the drawing) performing a desired operation using a liquid L (which will be described below) such as, for example, a hydraulic device. More specifically, the mechanical apparatus 1 may be various types of devices or robots for construction, civil engineering, manufacturing, or the like, vehicles used for transportation or the like, or a combination thereof.

The mechanical apparatus 1 includes a measuring device 10, a measuring sensor 11, a management device 12, a communication device 13, an output device 14, an acceleration sensor 151, a gyro sensor 152, a temperature sensor 153, a pressure sensor 154, a flow rate sensor 155, and the like.

The measuring sensor 11 outputs, to the measuring device 10, a sensor value SO acquired by measuring particles included in the liquid L. Description will be given below of the details of the configuration of the measuring sensor 11.

The measuring device 10 includes a sensor control section 101, a contamination degree acquiring section 102, an output section 103, and the like. The sensor control section 101 controls the measuring sensor 11. The contamination degree acquiring section 102 acquires a degree of contamination C of the liquid L due to particles by integrating or the like the correction value SC acquired by correcting the sensor value SO from the measuring sensor 11. The output section 103 outputs the degree of contamination C to the management device 12.

The management device 12 manages the mechanical apparatus 1. The management device 12 may include any functions; however, the management device 12 includes at least an output section 121. The output section 121 outputs, to at least one of the communication device 13 and the output device 14, the degree of contamination C from the measuring device 10.

The output device 14 is used by an operator of the mechanical apparatus 1. The use of the output device 14 allows the operator to confirm various states of the mechanical apparatus 1.

The acceleration sensor 151 acquires the acceleration of the mechanical apparatus 1 at the position where the acceleration sensor 151 itself is provided. Here, the acceleration sensor 151 is one acquiring the acceleration in each of X, Y, and Z directions based on any coordinate system; however, the acceleration sensor 151 is not limited thereto. The gyro sensor 152 acquires the angular velocity of the mechanical apparatus 1 at the position where the gyro sensor 152 itself is provided. The temperature sensor 153 acquires the temperature of the liquid L used in the mechanical apparatus 1. The pressure sensor 154 acquires the pressure of the liquid L used in the mechanical apparatus 1. The flow rate sensor 155 acquires the flow rate of the liquid L used in the mechanical apparatus 1.

The number and the position of the measuring sensor 11 to be provided, and the number and the position of each of the acceleration sensor 151, the gyro sensor 152, the temperature sensor 153, the pressure sensor 154, and the flow rate sensor 155 to be provided are not particularly limited. However, as will be described in detail below, each of the acceleration sensor 151, the gyro sensor 152, the temperature sensor 153, the pressure sensor 154, and the flow rate sensor 155 is provided in numbers and at positions where it is possible to measure each of the environmental conditions relating to the liquid L for acquiring the degree of contamination C using the measuring sensor 11.

The mechanical apparatus 1 is connected with a management system 3 via a communication network 2. The management system 3 may include any functions such as managing the mechanical apparatus 1; however, only the functions associated with the measuring device 10 of the embodiment will be described below and description of other functions will be omitted.

The degree of contamination C acquired by the measuring device 10 is output to the management device 12 and is output to at least one of the communication device 13 and the output device 14. However, without being limited thereto, as long as the measuring device 10 has its own communication device 13 and output device 14, the degree of contamination C may be output to the communication device 13 and the output device 14 without being output to the management device 12. In addition, the values obtained using each of the acceleration sensor 151, the gyro sensor 152, the temperature sensor 153, the pressure sensor 154, and the flow rate sensor 155 are output from the management device 12 to the measuring device 10; however, without being limited thereto, the values may be output directly from each of the acceleration sensor 151, the gyro sensor 152, the temperature sensor 153, the pressure sensor 154, and the flow rate sensor 155 to the measuring device 10.

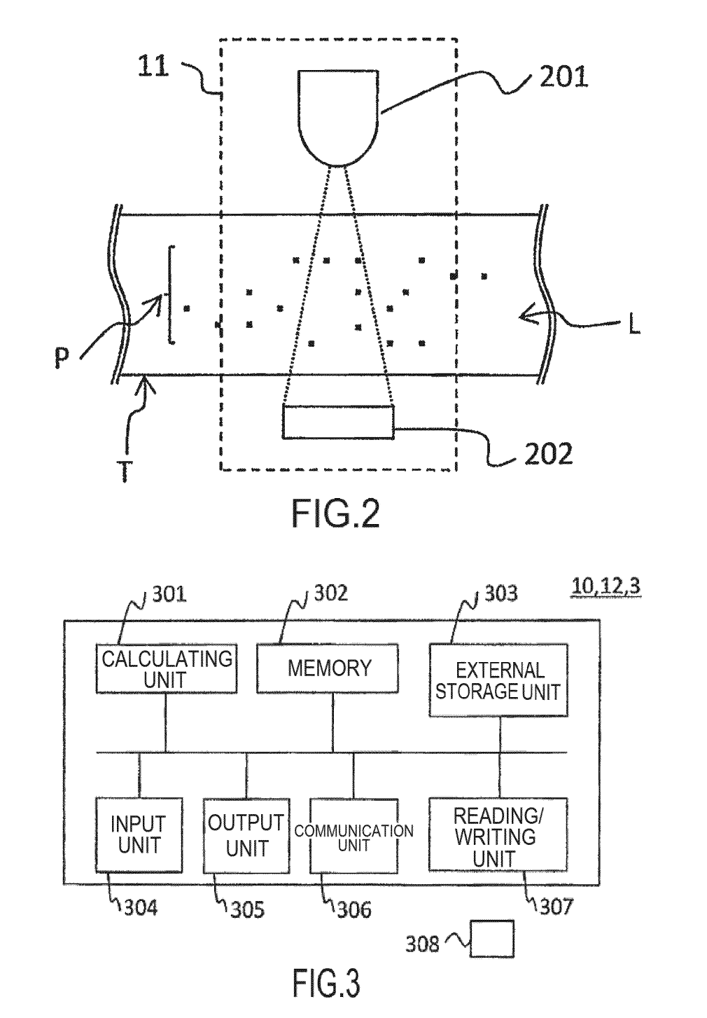

The measuring sensor 11 is known in the art; however, the configuration of the measuring sensor 11 will be described briefly below. FIG. 2 is a configuration diagram of the measuring sensor 11.

The measuring sensor 11 includes a light emitting section 201 and a light receiving section 202. The light emitting section 201 is, for example, a light emitting diode (LED) or the like. The light receiving section 202 is, for example, a photodiode or the like. The light emitting section 201 and the light receiving section 202 are disposed to face each other with a tube T interposed therebetween such that the light receiving section 202 can receive light from the light emitting section 201.

The liquid L flows through a hollow section of the tube T. Particles P are included in the liquid L. The amount of the particles P increases due to various factors such as deterioration in the tube T or other constituent components of the mechanical apparatus 1, deterioration of the liquid L, or permeation of particles from external sections.

In a case where the particles P are present in the liquid L which flows in the hollow section of the tube T between the light emitting section 201 and the light receiving section 202, the light from the light emitting section 201 is absorbed, scattered, attenuated, and the like by the particles P. Accordingly, it is possible for the measuring sensor 11 to measure the amount of the particles P based on the amount of light received in the light receiving section 202. The measuring sensor 11 outputs the amount of light received in the light receiving section 202 to the measuring device 10 as the sensor value SO.

FIG. 3 is a hardware configuration diagram for each of the measuring device 10, the management device 12, and the management system 3. Each of the measuring device 10, the management device 12, and the management system 3 has a calculating unit 301, a memory 302, an external storage unit 303, an input unit 304, an output unit 305, a communication unit 306, a reading/writing unit 307, and the like. The above are connected with each other by a bus or the like.

The calculating unit 301 is, for example, a central processing unit (CPU) or the like. The memory 302 is a volatile memory. The external storage unit 303 is, for example, a non-volatile memory such as a hard disk drive (HDD) or a solid-state drive (SSD). The input unit 304 is, for example, a keyboard, a mouse, a microphone, a touch panel, or the like. The output unit 305 is, for example, a display unit, a speaker, a printer, a touch panel, or the like. Each of the measuring device 10, the management device 12, and the management system 3 is connected with the communication network 2 via a communication unit 306. The reading/writing unit 307 writes information to a portable storage medium 308 and reads information from a portable storage medium 308.

Note that, although not illustrated in the drawings, the measuring device 10 and the management device 12 include an interface which connects with each of the measuring sensor 11, the acceleration sensor 151, the gyro sensor 152, the temperature sensor 153, the pressure sensor 154, and the flow rate sensor 155, or other devices.

Each of the sections of the measuring device 10 and the management device 12 may be realized by executing a program loaded into the memory 302 by the calculating unit 301. Such a program may be stored in advance in the memory 302, the external storage unit 303, or the like. The reading/writing unit 307 may read and install the program stored in the portable storage medium 308, or may install the program downloaded from the communication network 2 via the communication unit 306.

All or some of the sections of the measuring device 10 and the management device 12 may be realized as hardware. Alternatively, the measuring device 10 and the management device 12 may be realized by one device or the like, or may be realized by a plurality of devices in a distributed manner.

The communication device 13 is realized by the communication unit 306. In addition, the output device 14 is realized by the output unit 305.

Note that each of the sections described above is configured for the sake of convenience and some constituent components may be included in other constituent components, or may also be further divided or the like. In addition, each of the measuring device 10, the management device 12, and the management system 3 needs to include only necessary configurations and does not need to include the entirety of the configuration illustrated in FIG. 3. For example, only a device performing the output process described below needs to include the output unit 305. In addition, only a device connecting with communication network 2 needs to include the communication unit 306.

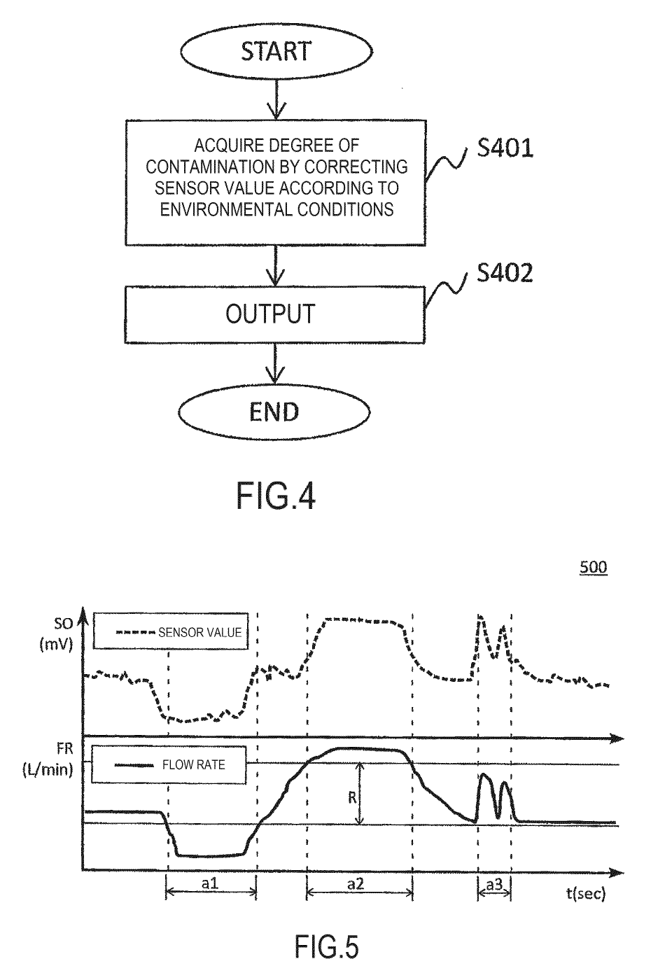

Next, description will be given of the operation of the measuring device 10. FIG. 4 is an operation flow where the measuring device 10 acquires the degree of contamination C. The operation may be started at any timing, for example, at predetermined time intervals. In addition, the operation may be started when the mechanical apparatus 1 is started, or may be started when an instruction is input to the mechanical apparatus 1 or the measuring device 10.

Values obtained, at predetermined time intervals (for example, every second), by each of the acceleration sensor 151, the gyro sensor 152, the temperature sensor 153, the pressure sensor 154, and the flow rate sensor 155 are input, at any timing, from the management device 12 to the measuring device 10. The values may be stored in, for example, the memory 302, the external storage unit 303, or the like, or may be stored in a storage circuit (not illustrated in the drawing) such as a latch circuit. In addition, the sensor control section 101 acquires the sensor value SO from the measuring sensor 11 at predetermined time intervals (for example, every second). The sensor value SO may be stored in, for example, the memory 302, the external storage unit 303, or the like, or may be stored in a storage circuit such as a latch circuit.

The contamination degree acquiring section 102 acquires the correction value SC by correcting the sensor value SO according to environmental conditions and acquires the degree of contamination C by integrating or the like the correction value SC (S401). The environmental conditions are at least one of the flow rate of the liquid L, the vibration applied to the measuring sensor 11, and the ambient temperature of the measuring sensor 11. Detailed description will be given below.

In addition, here, the contamination degree acquiring section 102 acquires the degree of contamination C by converting the correction value SC to an ISO standard (for example, ISO Cleanliness Code 4406-1999). However, without being limited thereto, the degree of contamination C may be acquired by being converted to a National Aerospace Standard (NAS) (for example, NAS 1638), other any standards, or the like. The degree of contamination C may be one indicating the amount of particles P included in the liquid L. Standards and/or conditions indicating the amount of particles P (for example, the units of the amount, the size of the particles, and the like) may be optionally determined.

The output section 103 outputs the degree of contamination C to the management device 12 (S402). The output section 103 may output the degree of contamination C to the management device 12 every time the degree of contamination C is acquired by the contamination degree acquiring section 102 or may collectively output a plurality of degrees of contamination C to the management device 12.

Next, detailed description will be given of the acquisition of the degree of contamination C by the contamination degree acquiring section 102 (S401). In the embodiment, the contamination degree acquiring section 102 is capable of acquiring the degree of contamination C using one or more of a plurality of techniques described below. The type of technique to be used is not particularly limited and one technique may be used according to the environmental conditions, the installation location of the measuring sensor 11, the type of the mechanical apparatus 1, or the like, or a plurality of techniques may be combined.

### [Technique 1]

Technique 1 is for correcting the sensor value SO according to the flow rate FR of the liquid L. In the embodiment, the flow rate FR of the liquid L is acquired from the values obtained by the flow rate sensor 155; however, without being limited thereto, the flow rate FR may be acquired by a technique known in the art using, for example, a pressure value obtained by the pressure sensor 154, the length of the tube T and a cross-sectional area of the hollow section thereof, an outflow coefficient, the fluid density, or the like, or the flow rate FR may be acquired by another technique known in the art. In addition, the acquisition of the flow rate FR from the pressure value or the like may be performed by the measuring device 10, or may be performed by the management device 12.

First, description will be given of the influence of the flow rate FR of the liquid L on the sensor value SO of the measuring sensor 11. FIG. 5 is an example showing the sensor value SO acquired by the measuring sensor 11 and the flow rate FR of the liquid L in time series.

Basically, each of the flow rate FR of the liquid L and a flow rate change ΔFR of the liquid L is set so as not to exceed a predetermined range or a predetermined threshold. However, since the mechanical apparatus 1 includes a mechanism which performs desired operations using the liquid L as described above, there are cases where the flow rate FR and the flow rate change ΔFR increase or decrease to temporarily exceed the predetermined range or the predetermined threshold due to the operation of the mechanism. In addition, when the mechanical apparatus 1 includes a moving mechanism, there are cases where the flow rate FR and the flow rate change ΔFR increase or decrease to temporarily exceed the predetermined range or the predetermined threshold due to the damper performance of the moving mechanism or the conditions of the road surface on which moving takes place.

As described above, the measuring sensor 11 measures the amount of particles P based on absorption, scattering, attenuation, and the like due to the particles P. Accordingly, even when the amounts of particles P included in a predetermined volume of the liquid L are the same, since the amount of absorption, scattering, attenuation, and the like due to the particles P increases when the flow rate FR of the liquid L and the flow rate change ΔFR increase, the amount of particles P is recognized to be greater than the actual amount. In contrast to this, since the amount of absorption, scattering, attenuation, and the like due to the particles P decreases when the flow rate FR of the liquid L is reduced, the amount of particles P is recognized to be less than the actual amount.

For example, the flow rate FR in period a1 in FIG. 5 is less than a predetermined range R. The flow rate FR in period a2 is greater than the predetermined range R. The flow rate change ΔFR in period a3 is greater than a predetermined range.

As shown in the drawing, the sensor value SO in a period corresponding to period a1 rapidly decreases in comparison with the value up to that point. The sensor value SO in a period corresponding to period a2 rapidly increases in comparison with the value up to that point. The sensor value SO in a period corresponding to period a3 rapidly increases in comparison with the value up to that point and then rapidly decreases. Since the sensor value SO in each of period a1, period a2, and period a3 returns to a value in the vicinity of that prior to the rapid decrease and the rapid increase after the rapid decrease and the rapid increase in the sensor value SO, it is understood that these values do not reflect the amount of the particles P actually included in the liquid L.

Technique 1 described below corresponds to a case as described above. More specifically, in a case where the flow rate FR of the liquid L is not in the predetermined range or the flow rate change ΔFR exceeds the predetermined threshold, technique 1 sets the sensor value SO prior thereto as the correction value SC.

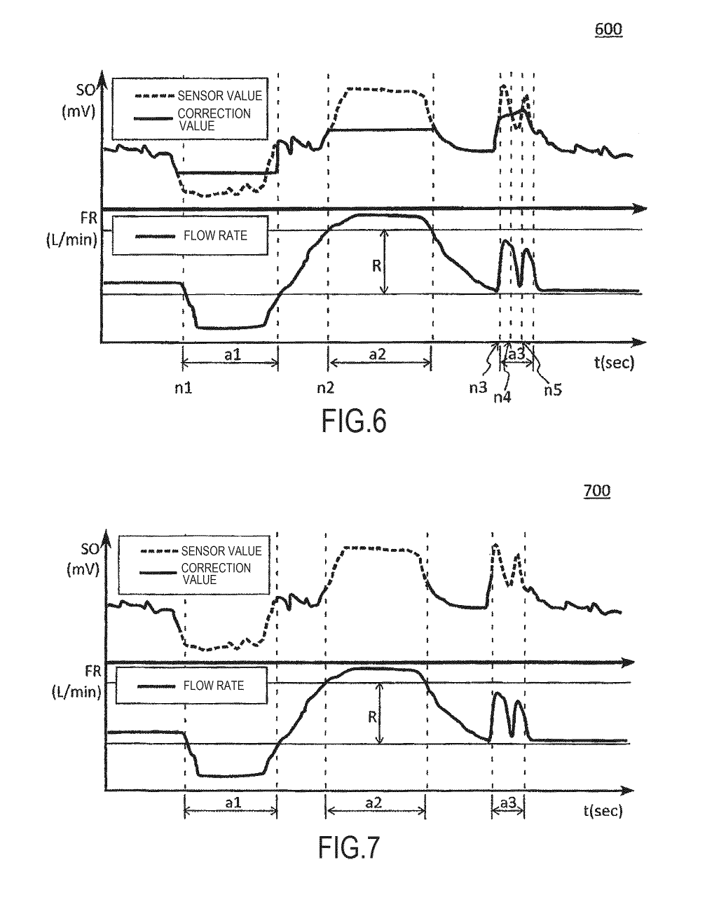

FIG. 6 is an example showing the sensor value SO output by the measuring sensor 11, the correction value SC where the sensor value SO is corrected, and the flow rate FR of the liquid L in time series in technique 1. As shown in a graph 600, the sensor value SO and the correction value SC are not matched in period a1, period a2, period a3, and periods in the vicinity thereof, and the sensor value SO and the correction value SC are matched in other periods.

In order to realize the graph 600, the contamination degree acquiring section 102 operates, for example, as in the following (1) to (5). Below, for the purpose of illustration, each of the flow rate FR, the flow rate change ΔFR, the sensor value SO, and the correction value SC at a certain time point n is indicated as a flow rate FRₙ, a flow rate change ΔFRₙ, a sensor value SOₙ, and a correction value SCₙ.

(1) The contamination degree acquiring section 102 determines whether or not the present flow rate FRₙ is in a predetermined range R. In a case where the determination result is that the flow rate FRₙ is in the predetermined range R, the contamination degree acquiring section 102 moves to (2) described below. On the other hand, in a case where the determination result is that the flow rate FRₙ is not in the predetermined range R, the contamination degree acquiring section 102 moves to (3) described below.

(2) The contamination degree acquiring section 102 determines whether or not the flow rate change ΔFRₙ which is the difference between a flow rate FRₙ₋₁ previously acquired and the present flow rate FRₙ exceeds a predetermined threshold. In a case where the determination result is that the flow rate change ΔFRₙ does not exceed the predetermined threshold, the contamination degree acquiring section 102 moves to (4) described below. On the other hand, in a case where the determination result is that the flow rate change ΔFRₙ does exceed the predetermined range, the contamination degree acquiring section 102 moves to (5) described below.

(3) The contamination degree acquiring section 102 sets, as the correction value SCₙ, a sensor value SOₙ₋ₘ (where n>m) in a flow rate FRₙ₋ₘ which has been acquired before this step and which is the latest one out of sensor values SOₙ₋ₘ where corresponding flow rates FRₙ₋ₘ are in the predetermined range R.

(4) The contamination degree acquiring section 102 sets the sensor value SOₙ as the correction value SCₙ.

(5) The contamination degree acquiring section 102 sets a sensor value SOₙ₋₁ (where n>1) as the correction value SCₙ.

According to the operation described above, in a period including period a1, the contamination degree acquiring section 102 sets a sensor value SOₙ₁ at a time point n1 as a correction value SCₙ₁. In a period including period a2, the contamination degree acquiring section 102 sets a sensor value SOₙ₂ at a time point n2 as a correction value SCₙ₂. From a time point n3 to a time point n4 in a period including period a3, the contamination degree acquiring section 102 sets a sensor value SOₙ₃ at the time point n3 as a correction value SCₙ₃. From the time point n4 to a time point n5, the contamination degree acquiring section 102 sets a sensor value SOₙ₄ at the time point n4 as a correction value SCₙ₄. From the time point n5 to a time point n6, the contamination degree acquiring section 102 sets a sensor value SOₙ₅ at the time point n5 as a correction value SCₙ₅.

In (5) described above, the relationship between “n” and “1” is not particularly limited. It is sufficient if the difference between “n” and “1” is 1 or more, and, for example, the difference may be set to be larger as the flow rate change ΔFR increases and to be smaller as the flow rate change ΔFR decreases. In addition, in a case where the time interval between “n” and “1” is longer than the time interval where the degree of contamination C is output from the measuring device 10 to the management device 12, the contamination degree acquiring section 102 may acquire the degree of contamination C to be output by interpolating values between the correction values SC using a technique known in the art such as regression analysis. Note that the graph 600 shows interpolated values.

Note that each of the ranges and thresholds used in the process in technique 1 may be the same as in the other techniques which will be described below or may be different.

### [Technique 2]

Technique 2 is for correcting the sensor value SO according to the flow rate of the liquid L. Technique 2 is different from technique 1 described above in the point that, in cases where the flow rate FR of the liquid L is not in the predetermined range or the flow rate change ΔFR exceeds the predetermined threshold, the correction value SC is not acquired in this state.

FIG. 7 is an example showing the sensor value SO output by the measuring sensor 11, the correction value SC acquired by the contamination degree acquiring section 102, and the flow rate FR of the liquid L in time series in technique 2. As shown in a graph 700, the correction value SC is not acquired in period a1, period a2, period a3, and periods in the vicinity thereof and the sensor value SO and the correction value SC are matched in other periods.

In order to realize the graph 700, the contamination degree acquiring section 102 operates, for example, as in the following (1) to (4).

(1) The contamination degree acquiring section 102 determines whether or not the present flow rate FRₙ is in a predetermined range R. In a case where the determination result is that the flow rate FRₙ is in the predetermined range R, the contamination degree acquiring section 102 moves to (2) described below. On the other hand, in a case where the determination result is that the flow rate FRₙ is not in the predetermined range R, the contamination degree acquiring section 102 moves to (3) described below.

(2) The contamination degree acquiring section 102 determines whether or not the difference between a flow rate FRₙ₋₁ previously acquired and the present flow rate FRₙ, that is, the flow rate change ΔFRₙ exceeds a predetermined threshold. In a case where the determination result is that the flow rate change ΔFRₙ does not exceed the predetermined threshold, the contamination degree acquiring section 102 moves to (4) described below. On the other hand, in a case where the flow rate change ΔFRₙ does exceed the predetermined threshold, the contamination degree acquiring section 102 moves to (3) described below.

(3) The contamination degree acquiring section 102 stops acquiring the correction value SCₙ.

(4) The contamination degree acquiring section 102 sets the sensor value SOₙ as the correction value SCₙ.

According to the operation described above, as shown in the graph 700, the contamination degree acquiring section 102 stops acquiring the correction value SC in the period including the period a1, the period a2, and the period a3.

While the acquisition of the correction value SC is stopped, the output section 103 may stop the output of the degree of contamination C to the management device 12. Alternatively, the output section 103 may output, instead of the degree of contamination C, information indicating that the acquisition of the degree of contamination C is stopped to the management device 12.

Note that each of the ranges and thresholds used in the process in technique 2 may be the same as in the other techniques or may be different.

### [Technique 3]

Technique 3 is for correcting the sensor value SO according to the flow rate of the liquid L. Technique 3 is different from technique 1 and technique 2 described above in the point that, in a case where the flow rate change ΔFR exceeds the predetermined threshold, the time interval where the sensor value SO is acquired is changed according to the degree of the flow rate change ΔFR and the correction value SC is acquired from the sensor value SO in the changed time interval.

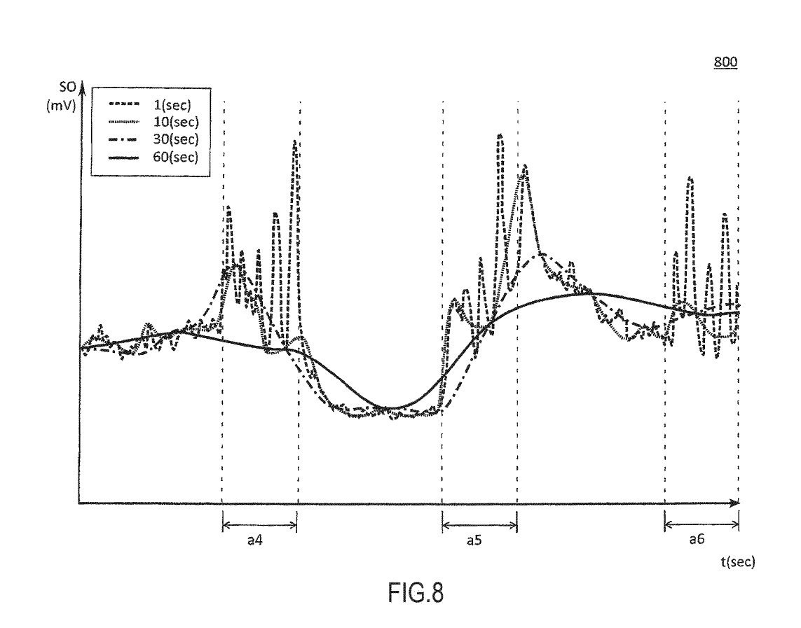

FIG. 8 is an example showing the sensor value SO in time series in technique 3, the sensor value SO being acquired in various time intervals. A graph 800 shows examples of cases where the sensor value SO is acquired at each of time intervals of 1 second, 10 seconds, 30 seconds, and 60 seconds. Each of a period a4, a period a5, and a period a6 is a period where the flow rate change ΔFR rapidly increases and decreases beyond the predetermined threshold.

In order to correct the sensor value SO according to the flow rate of the liquid L, the contamination degree acquiring section 102 operates, for example, as in the following (1) to (7).

(1) The contamination degree acquiring section 102 determines whether or not the difference between a flow rate FRₙ₋₁ previously acquired and the present flow rate FRₙ, that is, the flow rate change ΔFRₙ, exceeds a first threshold. In a case where the determination result is that the flow rate change ΔFRₙ does not exceed the first threshold, the contamination degree acquiring section 102 moves to (4) described below. On the other hand, in a case where the flow rate change ΔFRₙ does exceed the first threshold, the contamination degree acquiring section 102 moves to (2) described below.

(2) The contamination degree acquiring section 102 determines whether or not the flow rate change ΔFRₙ exceeds a second threshold (where the second threshold>the first threshold). In a case where the determination result is that the flow rate change ΔFRₙ does exceed the second threshold, the contamination degree acquiring section 102 moves to (3) described below. On the other hand, in a case where the flow rate change ΔFRₙ does not exceed the second threshold, the contamination degree acquiring section 102 moves to (5) described below.

(3) The contamination degree acquiring section 102 determines whether or not the flow rate change ΔFRₙ exceeds a third threshold (where the third threshold>the second threshold). In a case where the determination result is that the flow rate change ΔFRₙ does exceed the third threshold, the contamination degree acquiring section 102 moves to (7) described below. On the other hand, in a case where the flow rate change ΔFRₙ does not exceed the third threshold, the contamination degree acquiring section 102 moves to (6) described below.

(4) The contamination degree acquiring section 102 sets the sensor value SO acquired in a 1-second interval as the correction value SCₙ.

(5) The contamination degree acquiring section 102 acquires the correction value SCₙ from the sensor value SO acquired in a 10-second interval.

(6) The contamination degree acquiring section 102 acquires the correction value SCₙ from the sensor value SO acquired in a 30-second interval.

(7) The contamination degree acquiring section 102 acquires the correction value SCₙ from the sensor value SO acquired in a 60-second interval.

As is apparent from the above description, in technique 3, the time interval where the sensor value SO is acquired is lengthened in accordance with an increase in the flow rate change ΔFR and the time interval where the sensor value SO is acquired is shortened in accordance with a decrease in the flow rate change ΔFR. Due to this, it is possible to reduce differences between the sensor value SO and the actual amount of particles P due to rapid changes in the flow rate change ΔFR.

When the contamination degree acquiring section 102 acquires the time interval, the sensor control section 101 carries out control so as to acquire the sensor value SO in the acquired time interval. This operation may be realized by the sensor control section 101 controlling the output itself from the measuring sensor 11 or may be realized by the sensor control section 101 using the output from the measuring sensor 11 as it is and changing the time interval of the sensor value SO by thinning or the like.

Note that in a case where the time interval for output from the measuring device 10 to the management device 12 is longer than the time interval which is changed by the process described above, the contamination degree acquiring section 102 may acquire the degree of contamination C to be output by interpolating, with a technique known in the art such as regression analysis, values between the correction values SC acquired in the changed time interval.

The time interval to be changed is not limited to 1 second, 10 seconds, 30 seconds, or 60 seconds as described above. In addition, the number of stages of the time intervals is not limited to four. In addition, each of the ranges and thresholds used in the process in technique 3 may be the same as in the other techniques or may be different.

### [Technique 4]

Technique 4 is for correcting the sensor value SO according to vibration applied to the measuring sensor 11.

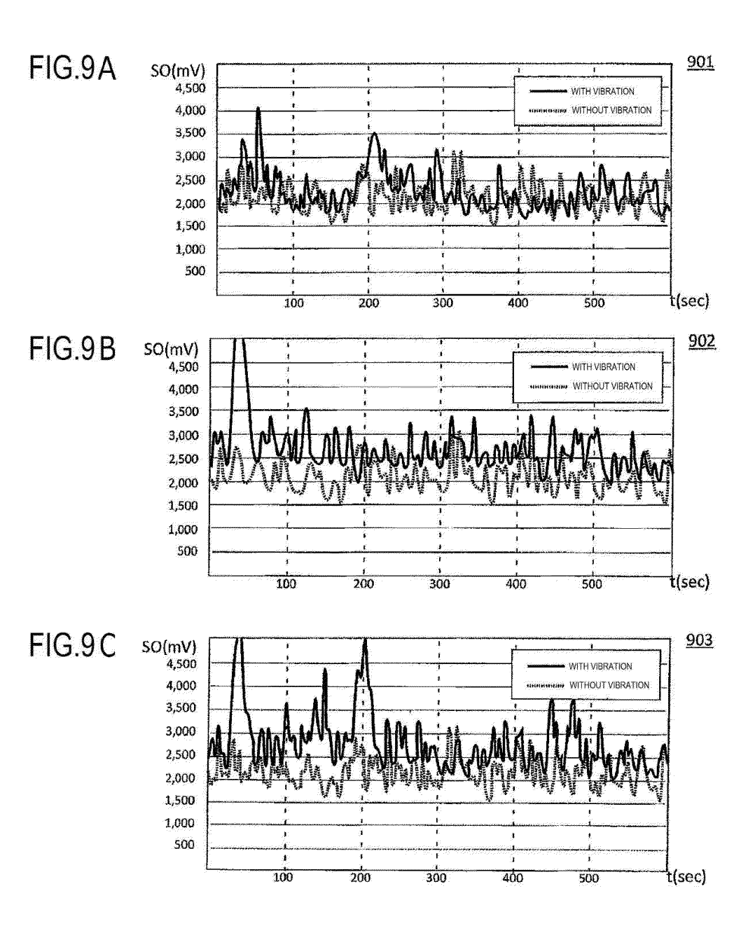

First, description will be given of the influence of the vibration on the sensor value SO of the measuring sensor 11. FIGS. 9A to 9C are examples showing, in time series, the sensor value SO in cases where vibration is applied to the measuring sensor 11 and the sensor value SO in cases where vibration is not applied to the measuring sensor 11. A graph 901 shows the sensor value SO with respect to vibration in an X direction, a graph 902 shows the sensor value SO with respect to vibration in a Y direction, and a graph 903 shows the sensor value SO with respect to vibration in a Z direction.

As described above, the measuring sensor 11 measures the amount of particles P based on absorption, scattering, attenuation, and the like due to the particles P. Accordingly, even when the amount of particles P included in a predetermined volume of the liquid L is the same, while vibration is being applied to the measuring sensor 11, the sensor value SO of the measuring sensor 11 is a value which deviates from the actual amount of particles P as in cases where the flow rate change ΔFR of the liquid L rapidly increases or decreases. In such a case, typically, the sensor value SO of the measuring sensor 11 which is greater than the actual amount of particles P is output.

For example, in the case of the graph 901, the sensor value SO in cases where vibration is being applied is output as a value which is approximately 8% greater than the sensor value SO in cases where vibration is not being applied. In the case of graph 902, the sensor value SO in cases where vibration is being applied is output as a value which is approximately 25% greater than the sensor value SO in cases where vibration is not being applied. In the case of graph 903, the sensor value SO in cases where vibration is being applied is output as a value which is approximately 25% greater than the sensor value SO in cases where vibration is not being applied.

Technique 4 described below corresponds to the cases described above. More specifically, technique 4 acquires the correction value SC by offsetting the sensor value SO according to the vibration conditions in the measuring sensor 11.

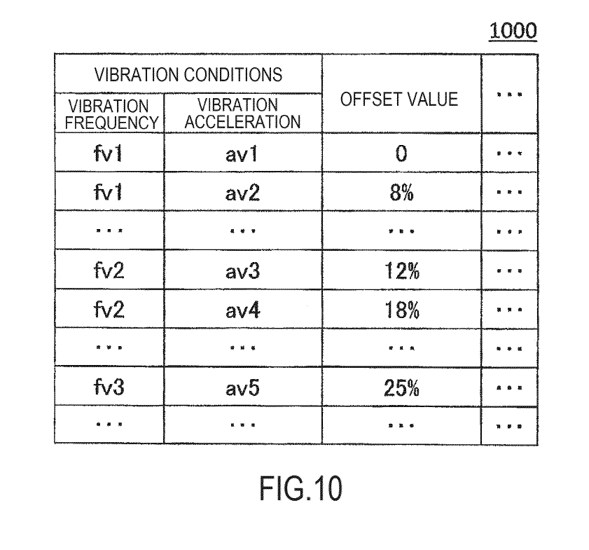

Here, description will be given of the offset value applied in technique 4. FIG. 10 is an example of an offset value applied to the sensor value SO according to the vibration conditions in the measuring sensor 11. As shown in Table 1000, offset values are set for each vibration condition. The offset values are set so as to increase as the vibration becomes stronger and decrease as the vibration becomes weaker.

The vibration conditions determining the offset values are not limited; however, as shown in the Table 1000, the offset values may be determined from the vibration frequency and the vibration acceleration. Techniques for acquiring each of the vibration frequency and the vibration acceleration are not limited; however, for example, the vibration frequency and the vibration acceleration may be acquired from the sensor values obtained by the acceleration sensor 151, the gyro sensor 152, and the like. In addition, at least one of the vibration frequency and the vibration acceleration may be determined according to the type of the mechanical apparatus 1, may be determined according to the installation location of the measuring sensor 11 in the mechanical apparatus 1, or may be determined from a combination thereof. This is because the generated vibration varies according to the object or operation of the mechanical apparatus 1, the damper performance of the moving mechanism, the distance from the measuring sensor 11 to the operation mechanism, or the like. In particular, it is suitable to determine the vibration acceleration from the type of moving mechanism in the mechanical apparatus 1 and the installation location of the measuring sensor 11 in the mechanical apparatus 1.

Alternatively, the vibration conditions determining the offset values may be a combination of at least two of the sensor values obtained by the acceleration sensor 151, the gyro sensor 152, and the like, the type of the mechanical apparatus 1, and the installation location of the measuring sensor 11 in the mechanical apparatus 1. Alternatively, values or the like which indicate the vibration conditions may be acquired using another technique known in the art.

The vibration conditions determining the offset values are not limited to the above. Displacement may be adopted as one of the vibration conditions determining the offset values. This displacement is, for example, full amplitude (peak to peak) or half amplitude (zero to peak) acquired using the acceleration sensor 151 and the gyro sensor 152 or other any technique known in the art. Alternatively, the offset values may be determined by combining one or more other any conditions (for example, vibration frequency, vibration acceleration, the type of the mechanical apparatus 1, the installation location of the measuring sensor 11 in the mechanical apparatus 1, and the like) with the displacement.

The contamination degree acquiring section 102 acquires the degree of contamination C by integrating or the like the correction value SC, the correction value SC being acquired by offsetting the sensor value SO from the measuring sensor 11 only by an offset value determined by the vibration conditions.

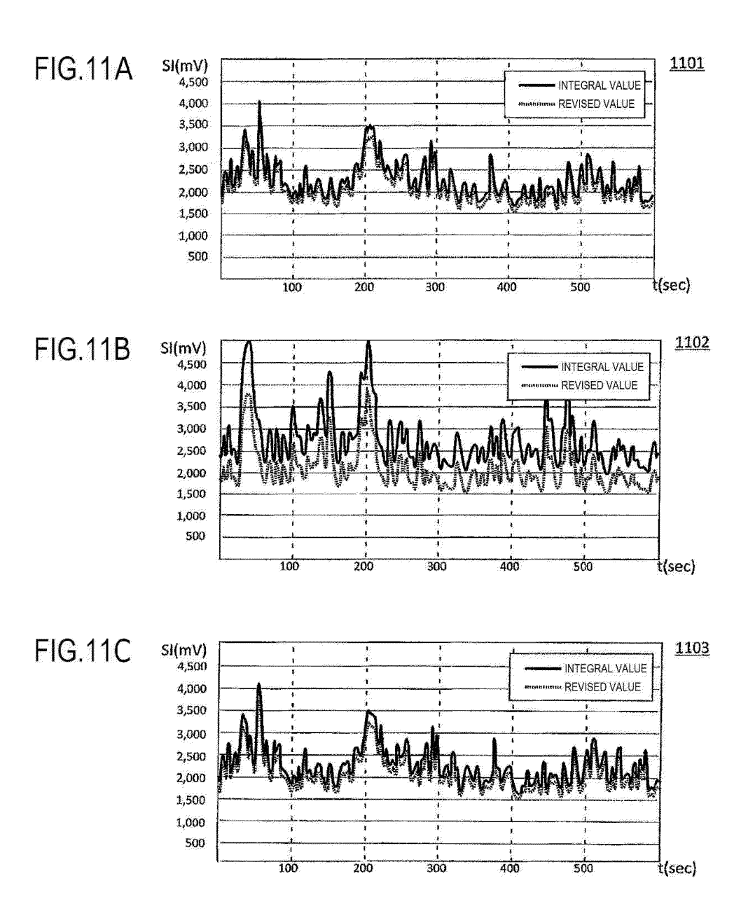

FIGS. 11A to 11C are examples showing, in time series, an integrated value SI where the sensor value SO is integrated in cases where vibration is applied to the measuring sensor 11 and an integrated value SI where the correction value SC acquired by offsetting the sensor value SO is integrated. A graph 1101 is an example where vibration is applied in the X direction, a graph 1102 is an example where vibration is applied in the Y direction, and a graph 1103 is an example where vibration is applied in the Z direction. As shown in the drawing, it is possible for the value which is integrated by offsetting the sensor value SO to better suppress the influence of the vibration in comparison with the value where the sensor value SO is integrated as it is.

Note that the vibration conditions determining the offset values are not limited to the above-described vibration frequency, vibration acceleration, the type of the mechanical apparatus 1, the installation location of the measuring sensor 11 in the mechanical apparatus 1, and the displacement, and may be any one of these, a combination of a plurality of these, or other any condition, or may be determined according to the position where the measuring sensor 11 is provided, a mechanism which is operated using the liquid L, or the like. In addition, the offset values are not limited to those shown in the drawing. In addition, the offset values may be given in the form of a table as shown in the drawing, or may also be calculated by substituting, in a predetermined formula which gives the offset values, variables (for example, the vibration frequency, the vibration acceleration, the type of the mechanical apparatus 1, the installation location of the measuring sensor 11 in the mechanical apparatus 1, the full amplitude, and the like) which express the vibration conditions.

### [Technique 5]

Technique 5 is for correcting the sensor value SO according to the ambient temperature of the measuring sensor 11. This technique is suitable in a case of using a light source where the output changes according to the temperature such as an LED as the light source of the light emitting section 201 of the measuring sensor 11.

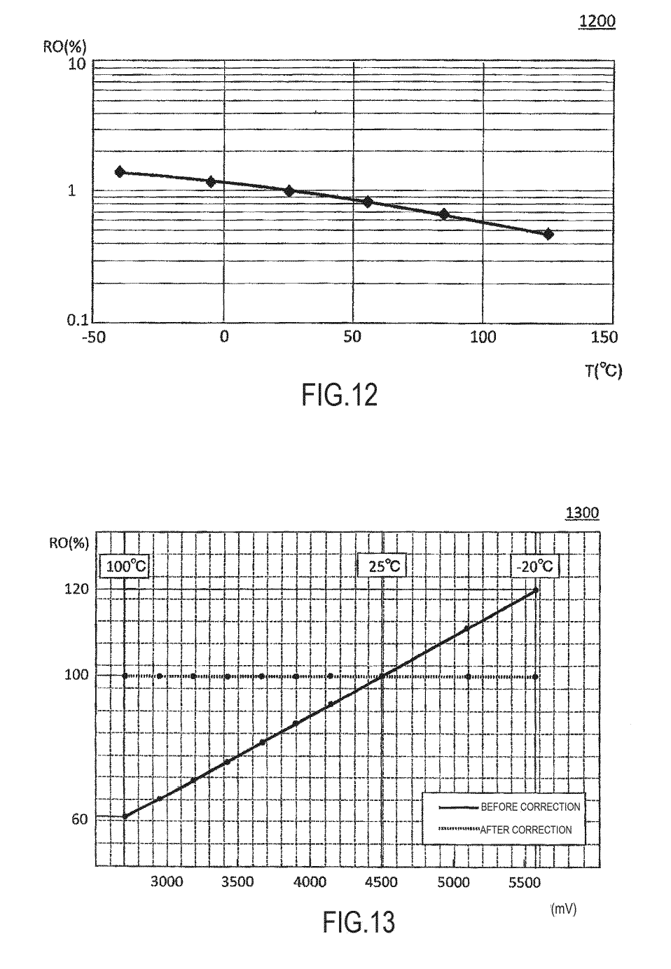

Description will be given of the influence of the ambient temperature on the output. FIG. 12 is an example showing the influence of the ambient temperature on the output of an LED. In a graph 1200, the horizontal axis is the ambient temperature and the vertical axis is a relative output RO of the LED when the output of the LED is set to 1 at an ambient temperature of 25° C. As shown in the graph 1200, the output of the LED decreases when the ambient temperature increases.

As described above, the measuring sensor 11 measures the amount of particles P according to the amount of light received by the light receiving section 202. Accordingly, even when the amount of particles P included in a predetermined volume of the liquid L is the same, in a case where the output value itself of the light emitting section 201 is higher or lower than an output value set as a reference, the sensor value SO of the measuring sensor 11 is a value which deviates from the actual amount of particles P. Typically, the ambient temperature of the measuring sensor 11 increases in accordance with the operation of the mechanical apparatus 1 in many cases, and accordingly, the sensor value SO of the measuring sensor 11 which is greater than the actual amount of particles P is output.

Technique 5 described below corresponds to a case as described above. More specifically, technique 5 acquires the correction value SC by correcting the sensor value SO according to the ambient temperature of the measuring sensor 11. The ambient temperature of the measuring sensor 11 is not particularly limited; however, the temperature is to be acquired by the temperature sensor 153. The temperature sensor 153 may measure the ambient temperature of the light emitting section 201 in the measuring sensor 11 or may measure the temperature of the liquid L measured by the measuring sensor 11. Alternatively, the ambient temperature of the measuring sensor 11 may be acquired using other techniques known in the art.

FIG. 13 is an example showing the sensor value SO output by the measuring sensor 11 and the correction value SC in technique 5. The horizontal axis in a graph 1300 is the sensor value SO and the vertical axis is the relative output RO of the LED when the output of the LED is set to 1 at an ambient temperature of 25° C. (the sensor value SO is approximately 4,500 mV). The line in the graph indicates the relative output RO at each ambient temperature.

As shown in the graph 1300, in a case where the amount of particles P is constant, the output of the sensor value SO decreases when the temperature of the liquid L increases. The contamination degree acquiring section 102 acquires the correction value SC, which is constant, by correcting the sensor value SO.

In order to realize the output shown in FIG. 13, the contamination degree acquiring section 102 may, for example, calculate the correction value SC by integration or the like using a correction coefficient, which is determined according to the ambient temperature of the measuring sensor 11, with the sensor value SO and acquire the contamination degree acquiring section C from the correction value SC. The correction coefficient is, for example, the value of the horizontal axis in the graph 1300 and it is possible to acquire the correction coefficient using a formula or the like obtained by experimentation.

Note that the light emitting section 201 may be controlled in order to correct the sensor value SO according to the ambient temperature of the measuring sensor 11, without being limited only to acquiring the correction value SC from the sensor value SO itself as described above. For example, the sensor control section 101 may control the measuring sensor 11 to increase and decrease the output value of the light emitting section 201 according to the ambient temperature of the measuring sensor 11. Due to this, for example, the contamination degree acquiring section 102 specifies the values which are determined according to the ambient temperature of the measuring sensor 11 and the sensor control section 101 may control the output of the light emitting section 201 by outputting the values or the like to the measuring sensor 11. The values are preferably determined such that the output of the light emitting section 201 increases when the ambient temperature increases and the output of the light emitting section 201 decreases when the ambient temperature decreases.

As described above, since the ambient temperature of the measuring sensor 11 often increases in accordance with the operation of the mechanical apparatus 1, in a case of controlling the output of the light emitting section 201, the output of the light emitting section 201 often increases. When the output of the light emitting section 201 increases, the lifetime of the light emitting section 201 is shortened depending on the characteristics of a device which realizes the light emitting section 201. Examples of devices with such a characteristic include LEDs. In order to compensate for this shortcoming, the correction of the sensor value SO itself and the control of the output of the light emitting section 201 may be combined. In contrast to this, in a case where the ambient temperature of the measuring sensor 11 decreases in accordance with the operation of the mechanical apparatus 1, the lifetime of the light emitting section 201 is lengthened when the output of the light emitting section 201 is controlled to be reduced. Accordingly, it is more suitable to control the output of the light emitting section 201 in such cases.

The above are techniques where the contamination degree acquiring section 102 corrects the sensor value SO. As described above, the degree of contamination C acquired by the contamination degree acquiring section 102 is output to at least one of the communication device 13 and the output device 14. Description will be given below of an example of the output.

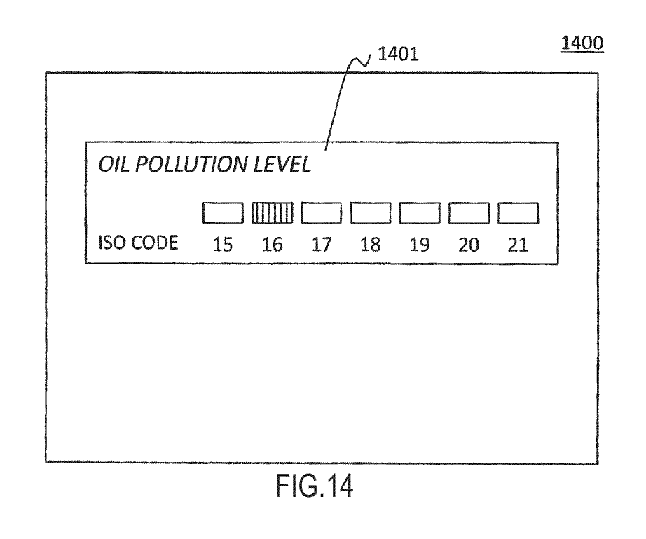

FIG. 14 is an example where the degree of contamination C is displayed on a display unit of the output device 14. A screen 1400 includes a region 1401 indicating the degree of contamination C at the present stage. It is possible to indicate the degree of contamination C in any form. For example, the degree of contamination C may be divided into a plurality of stages so as to indicate at which stage the degree of contamination C at the present stage is. Note that the region 1401 is an example where the degree of contamination C converted to ISO standards is displayed.

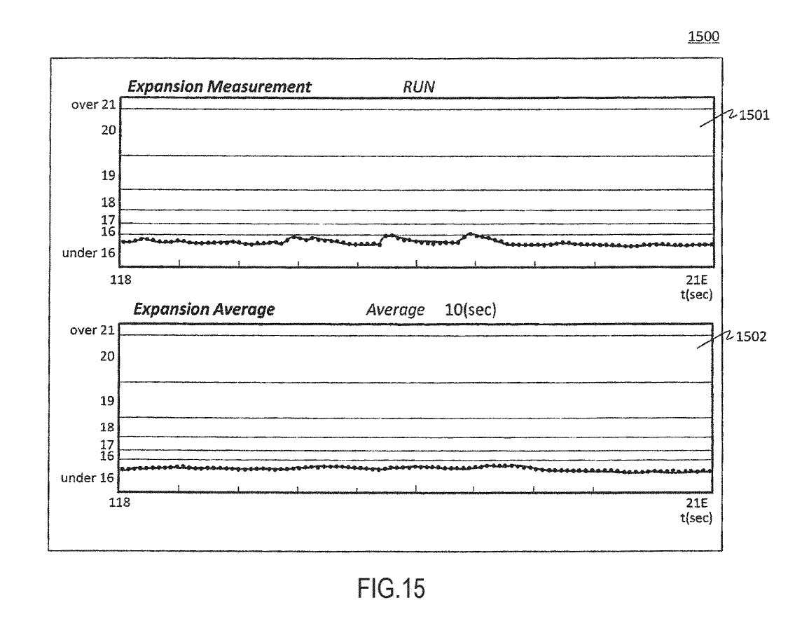

FIG. 15 is an example where the degree of contamination C is displayed on a display unit of the output unit 305 of the management system 3. The screen 1500 includes a graph 1501 and a graph 1502. The graph 1501 shows the degree of contamination C in time series at every predetermined time (for example, every second). The graph 1502 shows the average value of the degree of contamination C in time series at predetermined times (for example, the average value in 10 seconds).

Note that the display described above is an example and the type of display and the type of display unit are not limited. For example, the screen 1400 may be displayed on the display unit of the management system 3. In addition, the screen 1500 may be displayed on the display unit of the output device 14.

In addition, the degree of contamination C may be used not only in the output of the display or the like as described above, but also in processes in the mechanical apparatus 1 or the management system 3. More specifically, for example, desired processes may be performed according to the degree of contamination C. These processes are not particularly limited. For example, the processes include giving notification that the degree of contamination C exceeds a predetermined threshold, starting a process which performs filter replacement, cleaning, or the like, limiting the operation of the mechanical apparatus itself or of the constituent components which constituting the mechanical apparatus, and the like.

Note that the acquisition of the degree of contamination C itself, the setting of each of the thresholds or ranges used in the acquisition of the correction value SC or the like, and the acquisition of the coefficient, variables, or the like are performed by the measuring device 10 in the embodiment described above; however, it is not necessary that these processes be performed only by the measuring device 10. A part or all of the acquisition of the degree of contamination C, the setting of each of the thresholds or ranges used in the acquisition of the correction value SC or the like, and the acquisition of the coefficient, variables, or the like may be performed, for example, by another device such as the management device 12, the management system 3, or a processing device which is not illustrated in the drawing. In such a case, the measuring device 10 preferably outputs information, which is necessary in processes, to the other device and performs its own process in accordance with information which is input from the other device. Due to this, one or a plurality of the management device 12, the management system 3, and the processing device which is not illustrated in the drawing may include a function of accepting the input of the necessary information.

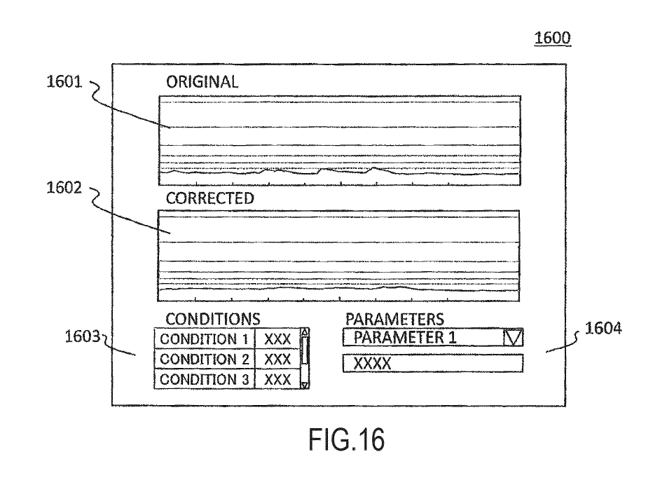

FIG. 16 is an example where a screen for inputting variables is displayed on the display unit. The output information to be displayed on the screen 1600 is generated by one or a plurality of the measuring device 10, the management device 12, and the management system 3, and output to the output unit 305 or a display unit of a device which is not illustrated in the drawing.

The screen 1600 includes a region 1601, a region 1602, a region 1603, a region 1604, and the like. The region 1601 indicates the degree of contamination before correction using the techniques described above. The region 1602 indicates a value when the degree of contamination indicated by the region 1601 is corrected in accordance with a threshold, range, coefficient, variable, or the like input to the region 1604. Note that, in FIG. 16, the region 1601 and the region 1602 indicate values of the degree of contamination in time series. The region 1603 indicates the environmental conditions when the degree of contamination indicated by the region 1601 is acquired, more specifically, for example, the flow rate or the flow rate change, the temperature, the vibration conditions, the operation of the mechanism apparatus 1, and the like. In addition, these conditions may be shown so as to overlap with at least one of the region 1601 and the region 1602 using a time series graph or the like.

Note that the display formats illustrated in FIGS. 14, 15, and 16 are examples and the display formats of the embodiment are not limited to thereto.

According to the embodiment, it is possible to accurately measure a degree of contamination due to particles included in a liquid used in a dynamic environment. Accordingly, it is possible to accurately measure the degree of contamination of the liquid even in cases where the state of the liquid changes due to the operation, movement, or the like of the mechanical apparatus. The embodiment is particularly suitable for various types of devices for construction, civil engineering, manufacturing, and the like, vehicles and the like for transportation or the like, and machines generating continuous vibration or machines performing heavy work.

Has been described in detail based on the embodiment the invention made by the present inventors, the present invention is not limited to the above embodiment and it is obvious that various changes are possible without departing from the scope of the present invention. For example, the above examples have been explained in detail in order to facilitate understanding of the present invention and are not necessarily limited to examples provided with the entirety of the configuration described above. In addition, it is possible to replace a part of the configuration of a certain embodiment with the configuration of another embodiment and it is also possible to add the configuration of another embodiment to the configuration of a certain embodiment. In addition, it is possible to make additions to each of the parts of the configuration of the embodiment, or to remove or replace such parts.

In addition, the control lines and information lines in each of the drawings described above are illustrated as far as considered necessary for the description; however, it is not necessarily the case that all the control lines and information lines which are actually implemented are shown. In practice, it may be considered that almost all the parts of the configuration are connected with each other.

What is claimed is:

1. A measuring device, comprising: a contamination degree acquiring section acquiring a degree of contamination of a liquid due to particles by correcting a sensor value from a measuring sensor for measuring particles in a liquid based on at least one of a flow rate of the liquid, vibration of the measuring sensor, and ambient temperature of the measuring sensor.

2. The measuring device according to claim 1, wherein
the contamination degree acquiring section acquires the degree of contamination by correcting the sensor value according to whether or not the flow rate of the liquid is in a predetermined range.

3. The measuring device according to claim 1, wherein
the contamination degree acquiring section acquires the degree of contamination by correcting the sensor value according to whether or not a flow rate change of the liquid exceeds a predetermined threshold.

4. The measuring device according to claim 1, wherein
the contamination degree acquiring section changes a time interval, at which the sensor value is acquired, according to a change amount in the flow rate of the liquid upon the change amount being not in a predetermined range, and acquires the degree of contamination from the sensor value acquired at the time interval.

5. The measuring device according to claim 1, wherein
the contamination degree acquiring section acquires the degree of contamination by correcting the sensor value according to at least one of vibration frequency, vibration acceleration, and displacement of the measuring sensor.

6. The measuring device according to claim 1, wherein
the measuring sensor includes a light emitting section and a light receiving section receiving light from the light emitting section, and
the contamination degree acquiring section performs at least one of changing an amount of light emitted by the light emitting section and correcting the sensor value according to the ambient temperature of the light emitting section.

7. A mechanical apparatus, comprising: the measuring device according to claim 1.

8. A measuring method executed by a computer, the method comprising the steps of:
acquiring a sensor value from a measuring sensor measuring particles in a liquid; and
acquiring a degree of contamination of the liquid due to the particles by correcting the sensor value based on at least one of a flow rate of the liquid, vibration of the measuring sensor, and ambient temperature of the measuring sensor.

9. A computer-readable storage medium storing a measuring program, the measuring program configured to
acquire a degree of contamination of a liquid due to particles by correcting a sensor value from a measuring sensor for measuring particles in a liquid based on at least one of a flow rate of the liquid, vibration of the measuring sensor, and ambient temperature of the measuring sensor.
